(19) United States
(12) Patent Application Publication
(10) Pub. No.: US 2025/0048972 A1
(43) Pub. Date: Feb. 13, 2025

(54) FIXED BLADE FOR AN AGRICULTURAL MACHINE

(71) Applicant: BOEHLERIT GmbH & Co.KG., Kapfenberg (AT)

(72) Inventors: Walter BÄRNTHALER, St. Marein im Mürztal (AT); Hannes BURBÖCK, Kindberg/Aumühl (AT)

(73) Assignee: BOEHLERIT GmbH & Co.KG., Kapfenberg (AT)

(21) Appl. No.: 18/799,320

(22) Filed: Aug. 9, 2024

(30) Foreign Application Priority Data
Aug. 11, 2023 (AT) A 50646/2023

(51) Int. Cl. A01F 29/00

(52) U.S. Cl. CPC A01F 29/005

(57) ABSTRACT

A blade for agricultural machines, for example, for harvesting machines and in particular a baler blade or loader wagon blade, including a substantially flat base body with a cutting area, in particular a curved cutting area, in which a cut of hay or the like is made when the base body is stationary. Cutting plates made of a carbide are arranged in the cutting area and the cutting plates are formed with cutting edges on an front side and with a first corner and a second corner. The cutting plates are arranged in plan view on an upper side of the base body in such a way that the second corner of a cutting plate lies behind a connecting line of the first corners of the cutting plates.

### CROSS-REFERENCE TO RELATED APPLICATION

This application claims priority under 35 U.S.C. § 119 (a) to Application No. A 50646/2023 filed Aug. 11, 2023, the disclosure of which is expressly incorporated by reference herein in its entirety.

### BACKGROUND

### 1. Field of the Invention

Embodiments relate to a blade for agricultural machines, for example, harvesting machines, in particular a baler blade or loader wagon blade, that includes a substantially flat base body with a cutting area, in particular a curved cutting area, in which a cut of hay or the like is made when the base body is stationary.

### 2. Discussion of Background Information

In agriculture, blades with a cutting area at the front are used in various agricultural machines to process straw and hay. The corresponding blades, for example, baler blades or loader wagon blades, are usually essentially flat and are arranged in a fixed position within the agricultural machine. In most cases, there is a large number of such blades in an arrangement through which the material to be cut is pressed. This means, for example, that hay that has already been cut can be shredded even further to the desired size.

Like cutting tools in general, fixed blades are subject to wear. Naturally, every effort is made to minimize wear and tear. The less wear there is, the less often a blade needs to be reworked, for example, by grinding or even being replaced. The less maintenance and/or replacement work required, the better a blade can be used per time, which increases productivity.

Based on the above considerations, a new trend has developed in recent years in cutting tools for agriculture, for example, to equip tillage implements such as goose foot shares or similar cutting tools made of steel with carbide cutting plates in the active cutting area. Such carbide cutting plates, which are usually formed from one or more metal carbides such as tungsten carbide and one or more binder metals, usually selected from the group consisting of cobalt, nickel and iron, must be manufactured separately and attached to the steel beam. While these carbide cutting plates may be more expensive than steel in terms of the basic materials, as the carbide cutting plates are associated with a longer service life than steel, the additional work steps and the higher material costs pay off in terms of a longer service life.

### SUMMARY

Based on the state of the art, it is the task of the embodiments to further develop a blade of the type mentioned at the outset in such a way that an increased service life can be achieved in use.

This task is solved by cutting plates made of a carbide arranged in the cutting area of a blade of the type mentioned at the outset. The cutting plates are formed with cutting edges and with a first corner and a second corner on a front side and are arranged in plan view of a top side of the base body in such a way that the second corner of a cutting plate lies behind a connecting line of the first corners of the cutting plates.

The intended arrangement of the cutting plates in the cutting area of the base body can increase the service life of the blade while maintaining good cutting quality. The cutting plates are arranged twisted in a top view of the top of the base body. The twist is selected so that the second corner of a cutting plate lies behind a connecting line formed by the first corners of the cutting plates. Usually, all second corners of the cutting plates lie behind this connecting line. This turning of the cutting plates in the actual cutting area results in the fact that, viewed from above on the upper side, the first corner of a cutting plate lies in front of the second corner of a subsequent cutting plate along a number of cutting plates towards an outer side in a blade of the type mentioned at the outset. This turning of the cutting plates results in an offset at the transition from one cutting plate to the next. Material to be cut, which is diverted from a cutting plate, can therefore get caught on one of the subsequent cutting plates and then be cut by it. These recesses are repeated along a chain of cutting plates so that the material to be cut can also be cut when, for example, it tends to slide outwards due to its texture and thus avoid the blade.

The cutting plates are basically designed in plan view with a front side and a back side, whereby the front side and back side are connected by two broad sides. The front side and the individual broad sides define the first corner and the second corner of a cutting plate. It is not mandatory, but in principle it is intended that all cutting plates used have the same shape. The cutting plates can be designed with specific contours on the front side, which have proven to be particularly useful for cutting straw, hay or similar materials. For example, the cutting plates can be designed with a front side that has a large number of teeth, between which the actual cutting areas of the cutting plates are defined by recessed rake faces with cutting lines. The recessed cutting lines can be U-shaped or V-shaped in plan view.

Well-known carbide is usually used for the cutting plates. For example, carbide grades with tungsten carbide as the hard material and cobalt as the binding metal can be used, whereby tungsten carbide can be partially replaced by titanium carbide and the binding metal may also include nickel and/or iron components. Typically, the carbide comprises more than 80% tungsten carbide, for example 85% to 95% tungsten carbide, the remainder being a binder metal, for example cobalt in the range of around 6% to 12%. Unless otherwise stated, all figures are in percent by weight.

The number of cutting plates is advantageously selected so that the cutting area of the base body can be essentially fully equipped with around 4 to 10, preferably 5 to 8 cutting plates. This ensures a sufficient number of recesses due to the twisting of the cutting plates. A smaller number of cutting plates is not very practical in this respect. Although more than ten cutting plates can also be used to cover the cutting area, this is less efficient as it involves additional work in terms of designing the base body with plate seats on the one hand and attaching the cutting plates on the other.

The cutting area of the base body on which the cutting plates are arranged is usually curved, although in extreme cases this curve can become a straight line. In particular, it may be provided that the first corners are arranged on a circular arc. In this case, the connecting line coincides with the arc of the circle, which has a certain radius. However, it is also possible for the curved cutting area to include merging circular arcs with different radii.

It is advantageously provided that the cutting plates are rotated by an angle of up to 15°, for example, more than 0° to 10°, preferably 1° to 9°, in particular 2° to 8°, relative to the connecting line when viewed from above on the upper side of the base body. The corresponding angle results from the angle between one front side of a specific cutting plate and the connecting line to the first corner of a subsequent cutting plate on the inside. There is no corresponding angle for the first cutting plate on the inside. Twisting by an angle of up to 15° can achieve the desired effects of a long service life and good cutting quality at the same time. Preferably, the corresponding angle is more than 0° to 10°, preferably 1° to 9°, more preferably 2° to 8°. A certain minimum angle is desired in order to have the intended transition from one cutting plate to the next cutting plate viewed from the outside. Particularly large angles make it difficult to grind the cutting plates, which will be explained later. In this respect, the preferred angles mentioned represent optimizations with regard to these properties.

Geometrically, the cutting plates are arranged in such a way that the first corners are closer to an outer side of the base body and the second corners are closer to an inner side of the base body. This defines that, viewed from the inside to the outside, the first corners of the cutting plates are on the outside and the second corners of the cutting plates are on the inside. This arrangement ensures that from one cutting plate to the next there is a gradation or a recess, so that the material to be cut can be repeatedly gripped by cutting plates virtually along the entire cutting area, provided it has not already been cut through by one of the previous cutting plates.

It is particularly advantageous if the cutting plates are arranged at an angle to the cutting edges when viewed from the front, with the first corner of a cutting plate being higher than the second corner of this cutting plate. This is due to the fact that the cutting plates must be ground from below before use and, if necessary, during maintenance. Due to the inclined position of the cutting plates, the first ends are clearly in front of the second corners from the perspective of a grinding cone that is guided along the cutting area. If the cutting plate is therefore to be ground in the area of the second corners towards the first corners, this would result in a large part of the cutting plate being removed by the grinding in the area of the first corners of the cutting plates if the cutting plates are aligned horizontally in accordance with the essentially flat base body. This can be optimally compensated for by the provided further inclination of the cutting plates, this time in relation to the height or the z-axis viewed from the base body plane. At the same time, this has no influence on the service life or the cutting quality.

The corresponding angle of an inclined position of the cutting plates can be up to 25°, preferably up to 17.5°, in particular up to 15°, for example 7.5° to 12.5°. An inclination greater than 25° is not required for compensation. Depending on the geometry of the base body and the curved area, lower threshold values for the specified areas may be required to achieve the desired compensation.

The cutting plates are advantageously arranged in such a way that they form an at least essentially continuous cutting line when viewed from the front. Although the cutting plates could also be arranged in the corresponding view so that they are spaced apart, the cutting area would then not be fully utilized. In addition, wear could also occur on the base body in the areas between the cutting plates. Therefore, a design with an arrangement in which the cutting plates form an essentially continuous cutting line is preferred.

As mentioned, the cutting plates can be made of a carbide. Advantageously, all cutting plates are made of the same carbide. The cutting plates can also have the same shape as described above. Typical carbide grades are used, for example, tungsten carbide-based systems with more than 85% tungsten carbide, the remainder cobalt and production-related impurities, whereby part of the cobalt can optionally be replaced by iron and/or nickel. Part of the tungsten carbide can also be replaced, for example up to 10% by other metal carbides such as titanium carbide. An average size of the metal carbide particles is usually in the range of 0.8 um to 3.5 um. Standard methods for determining the average grain size of a metal carbide powder are known to the skilled person, for example from DIN EN ISO 4499-3 2016-10.

The base body is usually made of steel. In order for an already known base body to have an improved design within the meaning of the invention, it is necessary for the base body to be designed with plate seats in which the cutting plates are arranged. The cutting plates are preferably arranged on the base body in a material-locking manner, in particular by soldering, in the plate seats provided. The plate seats can be dimensioned in such a way that they form a stop for a cutting plate on a rear side. It is preferable that the plate seats are shaped in such a way that they have an adapted shape in the area of a broad side adjoining the first corner and in the part of the rear side adjoining this broad side. This makes it very easy to bring a cutting plate into a desired position during soldering. The fact that the panel seat has a gap, particularly at the rear, is then irrelevant. It is particularly preferred that a contact is also formed on the broad side at the same time, which adjoins the second corner of the cutting plate. The cutting plate is then held by the plate seat on the broad sides and part of the rear side, and possibly along its entire length. This also results in simple positioning during soldering and a positive fixation for the use of the blade.

The cutting plates are advantageously ground on one underside. A grinding angle can be 5° to 25°, preferably 7.5° to 20°, in particular 8° to 18°. At the same time as the cutting plates are ground, part of the base body is also ground on the underside, which results from the arrangement of the cutting plates. This is also the case if the cutting plates protrude slightly beyond the plate seats. It is preferred within the scope of the invention that the cutting plates protrude slightly beyond the base body in the plate seats. This makes it easy to grind the cutting plates from below. Furthermore, a slight protrusion over the plate seat or the base body does not impair the stability of the cutting plates in the plate seats. However, any protrusion should be limited to a maximum of 5 mm so that the cutting plates are kept stable in the plate seats. During soldering and therefore also in the final position, this protrusion ultimately results from the fact that the cutting plate cannot be moved further back into the plate seat by hitting the plate seat. The shape of a plate seat relative to the cutting plate therefore also defines how far it protrudes beyond the plate seat or the base body.

Embodiments are directed to a blade for machines for agriculture. The blade includes a substantially flat base body with a curved cutting area, in which a cut is made when the base body is stationary. Cutting plates made of a carbide are arranged in the cutting area and the cutting plates have on a front side cutting edges, a first corner and a second corner. In plan view on an upper side of the base body, the cutting plates are arranged in such a way that the second corner of a cutting plate lies behind a connecting line of the first corners of the cutting plates.

According to embodiments, the connecting line of first corners can be an arc of a circle.

In accordance with embodiments, the cutting plates may be rotated by an angle α of up to 15° relative to the connecting line when viewed in the plan view on the upper side of the base body. The angle α may be greater than 0° to 10° relative to the connecting line when viewed in the plan view on the upper side of the base body, preferably 1° to 9° relative to the connecting line when viewed in the plan view on the upper side of the base body and most preferably between 2°and 8° relative to the connecting line when viewed in the plan view on the upper side of the base body.

In embodiments, the cutting plates may be arranged in such a way that the first corners are positioned closer to an outer side of the base body and the second corners are positioned closer to an inner side of the base body.

According to other embodiments, in a frontal view of the cutting edges, the cutting plates can be arranged obliquely relative to an imaginary plane running through the flat base body so that the first corner of at least one cutting plate is higher than the second corner of the at least one cutting plate. Further, an angle β of an inclined position of the cutting plates arranged obliquely to the imaginary plane running through the flat base body is greater than 0° up to 25°. The angle β may be up to 17.5°, preferably up to 15° and most preferably between 7.5° and 12.5°.

In accordance with other embodiments, in a frontal view of the cutting edge, the cutting plates can form an at least substantially continuous cutting line.

In still other embodiments, the carbide can include: at least one of tungsten carbide or titanium carbide; and a binder metal comprising at least one of cobalt, iron or nickel.

In other embodiments, the base body can be formed from a steel.

According to other embodiments, the base body may be formed with plate seats in which the cutting plates are arranged.

In other embodiments, the cutting plates can be soldered to the base body.

According to other embodiments, the cutting plates are ground on an underside. Further, a grinding angle γ of the cutting plates can be 5° to 25°, preferably 7.5° to 20° and most preferably 8° to 18°.

In accordance with still yet other embodiments, the blade can be one of a baler blade or loader wagon blade for a harvesting machine.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a first variant of a loader wagon blade with cutting plates;

FIG. 2 illustrates a second variant of a loader wagon blade with cutting plates;

FIG. 3 illustrates a third variant of a loader wagon blade with cutting plates;

FIG. 4 illustrates a baler blade with cutting plates;

FIG. 5 illustrates a further variant of a loader wagon blade with cutting plates in plan view;

FIG. 6 illustrates a front view of the loader wagon blade from FIG. 5;

FIG. 7 illustrates a view of the loader wagon blade from FIG. 5 and FIG. 6 from below;

FIG. 8 illustrates a section along line VIII-VIII in FIG. 7;

FIG. 9 illustrates an enlarged view of a grinding angle;

FIG. 10 illustrates a perspective view of a loader wagon blade with attached cutting plates in the unground state; and

FIG. 11 illustrates a perspective view of a loader wagon blade with cutting plates in the ground state

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

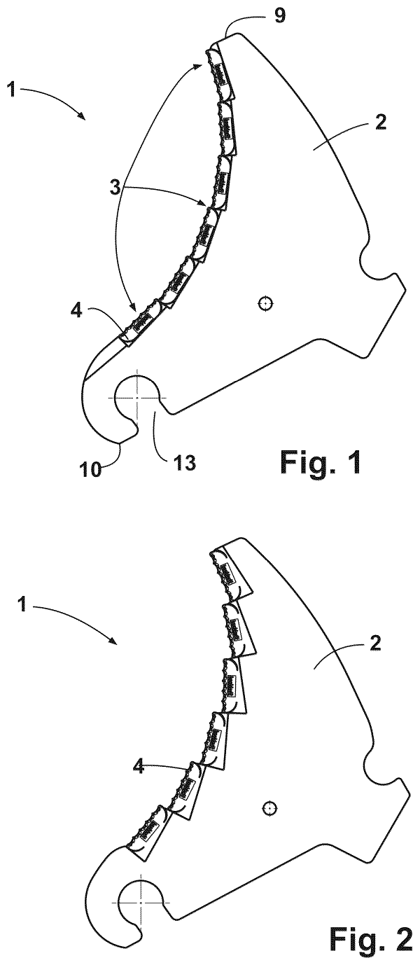

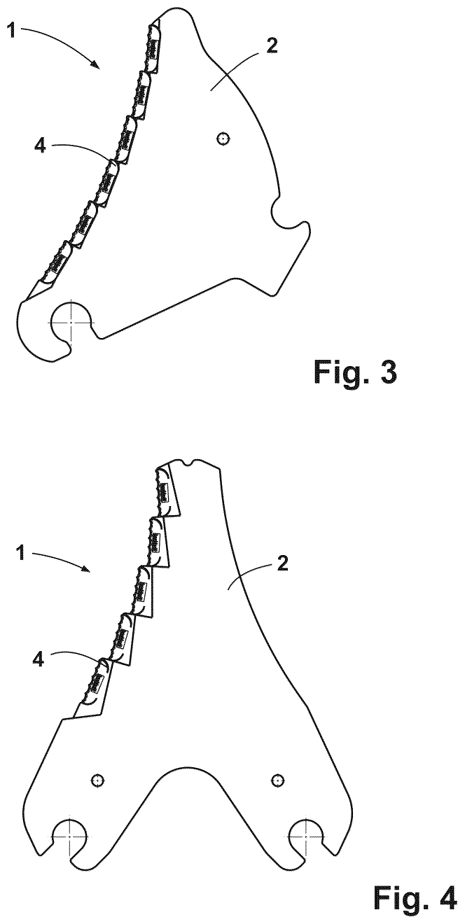

FIG. 1 through FIG. 4 show various blades 1 with different geometric shapes and equipped with cutting plates 4. The following explanations of the embodiment variant according to FIG. 1 apply analogously to the embodiments according to FIG. 2 through FIG. 4. The blades 1 shown in FIG. 1 through FIG. 3 are loader wagon blades. FIG. 4 shows a blade 1 in the form of a baler blade.

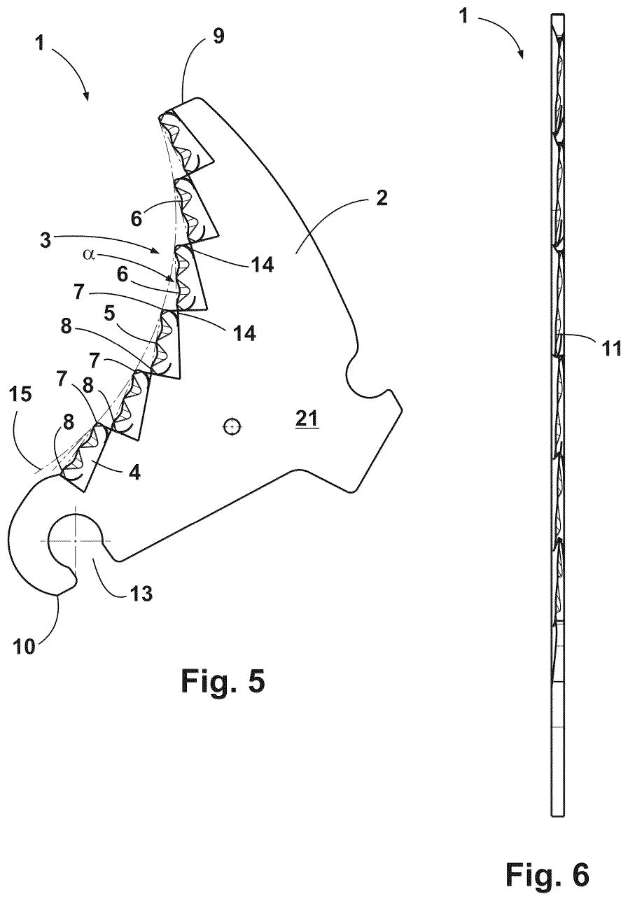

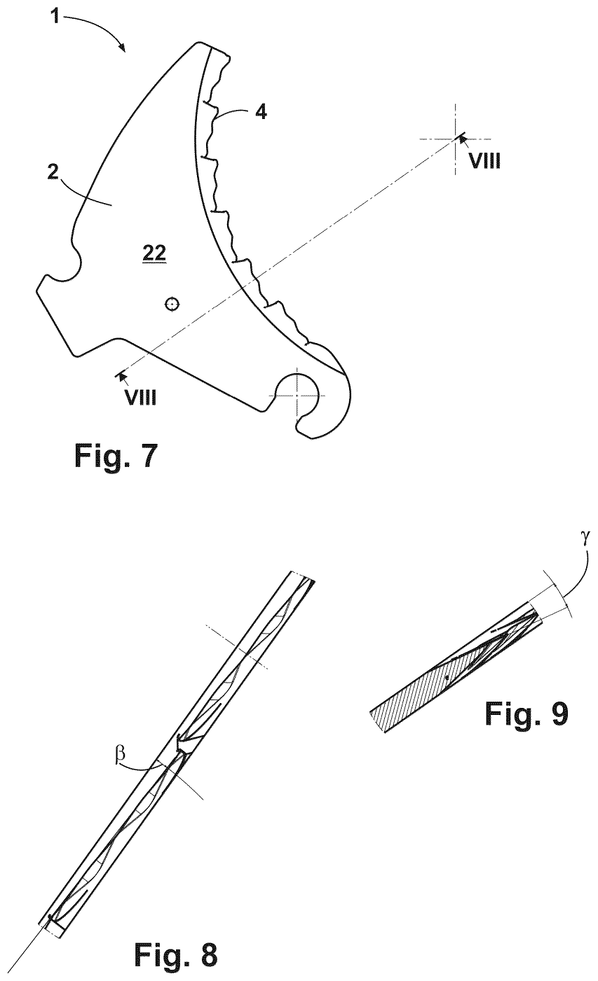

The blade 1 as shown in FIG. 1 comprises a base body 2 that is essentially flat. The base body 2 has a holder 13 which serves to fasten the base body 2 to a suitable tool carrier so that the base body 2 can be positioned relative to a rotor moving the material to be cut forwards. In order to be able to cut clippings such as hay, the blade 1 has a cutting area 3. By driving the material to be cut forward with the rotor, the material hits the cutting area 3 and is cut in this area. The cutting plates 4 are arranged in the cutting area 3. In all embodiments, the cutting plates 4 form a continuous line so that the cutting area 3 is at least essentially completely covered by the cutting plates 4. The cutting plates 4 extend from an inner side 10 of the base body, adjacent to the holder 13, to an outer side 9 of the base body 2. Since the cutting area 3 is curved, the arrangement of the cutting plates 4 also forms a corresponding curve, although the cutting plates 4 are arranged in a certain way, as explained in detail using another blade 1 according to FIG. 5 through FIG. 11 as an example.

The blade 1 shown in FIG. 5 again has a base body 2 with a large number of cutting plates 4, which are arranged in the cutting area 3. Viewed from the front (FIG. 6), the cutting plates 4 form a continuous cutting line 11 with their cutting edges 6, i.e. they are arranged without a gap so that the material to be cut in the cutting area 3 can only hit the cutting plates 4, but not the base body 2.

The cutting plates 4 are generally designed with a front side 5, which defines a cutting edge 6. The front side 5 of a cutting plate 4 is opposite a back side. The front side 5 is connected to the rear side via broad sides, resulting in an approximately rectangular shape for the cutting plates 4. The individual cutting plates 4 are secured in plate seats 14 by soldering. The plate seats 14 can be machined into the base body 2 by milling. Each plate seat 14 positively holds a single cutting plate 4. It is preferable that the cutting plate 4 comes to rest on the broad sides and partially or completely on the rear side in a plate seat 14. This keeps the cutting plate 4 aligned during soldering and stable during use.

In the area of the front side 5, a cutting plate 4 has a first corner 7 and a second corner 8. The first corner 7 and the second corner 8 are formed where the front side 5 merges into the broad sides.

The cutting plates 4 are arranged from the inside 10 towards the outside 9 in such a way that the second corners 8 lie behind a connecting line 15, which is formed by connecting the first corners 7 of the cutting plates 4. In the embodiment shown in FIG. 5, the first corners 7 lie on an arc of a circle with a predetermined radius. This is also the case with the design variants shown in FIG. 1 through FIG. 4, although the connecting line 15 does not necessarily have to be an arc of a circle. The shape of the connecting line 15 can deviate from a circular arc if the base body 2 has a different shape.

With reference to FIG. 5, it can be said that the cutting plates 4 are rotated in relation to the connecting line 15, in that the second corner 8 is rotated about an axis of rotation running through the first corner 7. A corresponding angle α can be up to 15°, for example 2° to 8°. This also results in a recess in the cutting line 11 from the inside 10 to the outside 9 along the cutting plates 4 from one cutting plate 4 to the next. This enables a particularly efficient cut to be achieved because the cut material is less likely to escape to the outside 9.

The cutting plates 4 are not only twisted in relation to an upper side 21, but also in the plane of the base body 2, which is flat. This can be seen in the enlarged view in FIG. 6 and also in FIG. 8. The first corners 7 are arranged higher than the second corners 8 relative to an imaginary plane that runs through the flat base body 2. A corresponding angle β of an inclined position of the cutting plates can be up to 25°. The corresponding angle β is usually in the range of 7.5° to 12.5°. This inclined position relative to the aforementioned imaginary plane makes it possible for the cutting plates to be ground on the underside 22 so that optimum cutting performance can be achieved. A grinding angle γ can be 5° to 25°. The cutting angle is usually in the range of 8° to 12°. In FIG. 9, for example, the grinding angle γ is 10°.

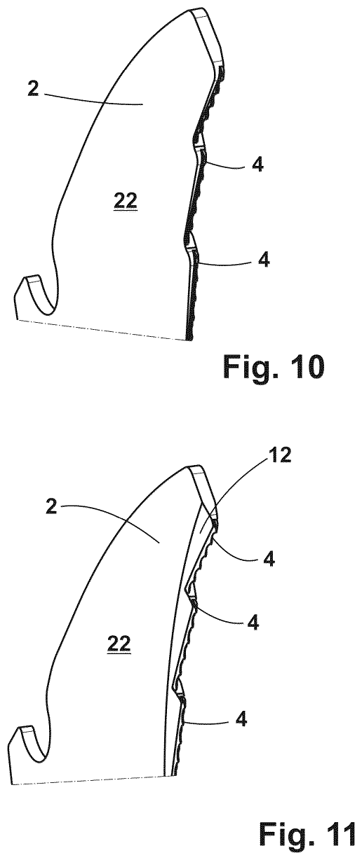

If the cutting plate 4 were not rotated relative to the imaginary plane running through the base body 2, noticeable parts of a cutting plate 4 would be ground off in the area of the first corners 7 when grinding on the underside 22. The inclined position relative to the imaginary plane ultimately compensates for the torsion shown in the top view so that an approximately uniform sanding process can be carried out along the entire front side 5. This can be seen in FIG. 10 and FIG. 11. FIG. 10 shows the underside 22 of the base body 2 with fixed cutting plates 4, which are fixed in the plate seats 14 and protrude slightly. This corresponds to a state in which the cutting plates 4 are already soldered to the base body 2, but the blade 1 is not yet ready for use because the cutting plates 4 have not yet been ground. A state after grinding is shown in FIG. 11. As can be seen, a part of the underside 22 of the base body 2 is also ground down during a grinding process, resulting in a bevel 12 on the base body 2. As can be seen in FIG. 11, the selected grinding angle γ of 10° results in a uniform projection beyond the plate seats 14 for all cutting plates 4 when the cutting plates 4 are ground. Due to the rotated arrangement of the cutting plates 4 by an imaginary rotation normal to the flat base body 2 around the first corners 7 on the one hand, and a rotation of the cutting plates 4 around an axis of rotation running parallel to the imaginary plane through the base body 2 on the other hand, optimum grinding can also be achieved with a long service life and good cutting effect.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A blade for machines for agriculture, comprising:
a substantially flat base body with a curved cutting area, in which a cut is made when the base body is stationary,
wherein cutting plates made of a carbide are arranged in the cutting area,
wherein the cutting plates have on a front side cutting edges, a first corner and a second corner,
wherein, in plan view on an upper side of the base body, the cutting plates are arranged in such a way that the second corner of a cutting plate lies behind a connecting line of the first corners of the cutting plates.

2. The blade according to claim 1, wherein the connecting line of first corners is an arc of a circle.

3. The blade according to claim 1, wherein the cutting plates are rotated by an angle α of up to 15° relative to the connecting line when viewed in the plan view on the upper side of the base body.

4. The blade according to claim 3, wherein the angle α is greater than 0° to 10° relative to the connecting line when viewed in the plan view on the upper side of the base body.

5. The blade according to claim 3, wherein the angle α is 1° to 9° relative to the connecting line when viewed in the plan view on the upper side of the base body.

6. The blade according to claim 1, wherein the angle α is 2° to 8° relative to the connecting line when viewed in the plan view on the upper side of the base body.

7. The blade according to claim 1, wherein the cutting plates are arranged in such a way that the first corners are positioned closer to an outer side of the base body and the second corners are positioned closer to an inner side of the base body.

8. The blade according to claim 1, wherein, in a frontal view of the cutting edges, the cutting plates are arranged obliquely relative to an imaginary plane running through the flat base body so that the first corner of at least one cutting plate is higher than the second corner of the at least one cutting plate.

9. The blade according to claim 8, wherein an angle β of an inclined position of the cutting plates arranged obliquely to the imaginary plane running through the flat base body is greater than 0° up to 25°.

10. The blade according to claim 8, wherein the angle β is up to 17.5°.

11. The blade according to claim 8, wherein the angle β is up to 15°.

12. The blade according to claim 8, wherein an angle β is between 7.5° to 12.5°.

13. The blade according to claim 1, wherein, in a frontal view of the cutting edge, the cutting plates form an at least substantially continuous cutting line.

14. The blade according to claim 1, wherein the carbide comprises at least one of tungsten carbide or titanium carbide and a binder metal comprising at least one of cobalt, iron or nickel.

15. The blade according to claim 1, wherein the base body is formed from a steel.

16. The blade according to claim 1, wherein the base body is formed with plate seats in which the cutting plates are arranged.

17. The blade according to claim 1, wherein the cutting plates are soldered to the base body.

18. The blade according to claim 1, wherein the cutting plates are ground on an underside.

19. The blade according to claim 18, wherein a grinding angle γ of the cutting plates is 5° to 25°.

20. The blade according to claim 19, wherein the grinding angle γ is 7.5° to 20°.

21. The blade according to claim 19, wherein a grinding angle γ is 8° to 18°.

22. The blade according to claim 1, wherein the blade is one of a baler blade or loader wagon blade for a harvesting machine.
